(19) United States
(12) Patent Application Publication
(10) Pub. No.: US 2012/0275571 A1
(43) Pub. Date: Nov. 1, 2012

(54) ROBOT ARRANGEMENT WITH A GUIDE ELEMENT FOR SUPPLY LINES

(76) Inventor: Wolfgang Neuber, Pressath (DE)

(21) Appl. No.: 13/282,263

(22) Filed: Oct. 26, 2011

(30) Foreign Application Priority Data
Oct. 29, 2010 (DE) 10 2010 043 121.4

(51) Int. Cl. B25J 19/00; B25J 18/00; H05G 1/02

(52) U.S. Cl. 378/194; 378/193; 74/490.02; 901/27; 901/30

(57) ABSTRACT

The present embodiments relate to an arrangement with a robot having a robot arm formed from arm members. The robot arm carries a device fed by at least one electrical supply line. The arrangement has at least one guide element fixed to one of the arm members for guidance of the at least one electrical supply line on the robot arm. The at least one guide element is arranged rotatably about a longitudinal axis of the one arm member.

This application claims the benefit of DE 10 2010 043 121.4, filed on Oct. 29, 2010.

### BACKGROUND

The present embodiments relate to an arrangement having a robot with a robot arm formed of arm members, the robot arm carrying a device fed by at least one electrical supply line.

A general problem in the case of robots (e.g., in configurations as 6-axis robots used in industry and in medical engineering) arises if a device carried by the robot arm is fed by a large number of electrical, hydraulic, pneumatic and/or other supply lines. The electrical, hydraulic, pneumatic and/or other supply lines may not be routed within the robot arm, as corresponding motion-related actions would need to be performed for each supply line in each joint of the robot arm. Accordingly, the supply lines may be routed to the device outside the robot arm. In order to protect the supply lines from damage, the supply lines may be arranged within a hose. Flexible hoses may be used for this purpose, as the flexible hoses exhibit a high degree of flexibility in all directions while being very robust.

Routing of the cables to peripheral equipment attached to the robot is to be close to the arm of the robot. Freely hung cables are not used in order to provide hazard-free and undisturbed treatment of the patient. The problem is further exacerbated by a great range of movement on the part of the robot, by large-diameter cables or cable bundles, and the minimum radii of bending of the cables to be maintained. In order that the freedom of movement of the arrangement is not limited, a certain reserve length of line/hose is to be provided. At the same time, the routing of the line or hose is to take place such that the hose and the supply lines accommodated within the hose are not damaged during movement of the robot arm and of the devices carried by the robot, and that the hose, which follows the movements of the robot arm with an inertia-related delay, does not cause damage to other components.

FIG. 1 shows an arrangement for the guidance of supply lines in the case of robots according to the prior art as in DE 10 2009 043 448.8. FIG. 1 shows a C-arm X-ray system 1 that includes a C-arm 2 with a radiation source 3 and a radiation detector 4. The C-arm 2 is arranged on a robot arm 5, which has a plurality of arm members 6 that are connected to each other, via revolute joints 7, to the C-arm 2 and a robot stand 8. The radiation source 3 and the radiation detector 4 arranged on the C-arm 2 are fed by supply lines (not shown) that are guided to the C-arm 2 in a hose 9. The hose 9 effects a bundling of the supply lines and provides protection against external influence and damage. The hose 9 is guided along individual arm members 6 by guide elements 10 and held close to the respective arm member 6 by the guide elements 10, so that an arm member 6 and the equivalent section of the hose 9 perform corresponding movements. Accordingly, collisions may not occur.

The guide elements 10 are embodied such that the hose 9 may slide through the guide elements 10 in the longitudinal direction if additional hose 9 is required as a result of a movement of the arm members 6 or of the C-arm 2, or if the hose 9 is released once more. The guide elements 10 may be supported in a rotatable and/or jointed manner (e.g., on a ball-and-socket joint with limiting cuff) in order to enable orientation of the guide elements 10 along a direction of span of the hose. Excessive kinking of the hose 9 at the guide elements 10 may thus be prevented.

A storage element 11 mounted on a ceiling of a treatment room (not shown), in which the C-arm X-ray system 1 is located, takes up the length of hose along with the amount of supply line necessary to provide the freedom of movement, and releases the hose and the supply line as required, depending on the movements performed by the robot arm 5. The storage element 11 releases the hose 9 when a tensile loading of the hose 9 increases through a movement of the robot arm 5 and retracts the hose 9 again when the tensile loading of the hose 9 diminishes as a result of a movement of the robot arm 5. The storage element may also be attached directly to the robot arm 5. The hose 9 ends on the C-arm 2 in a supply line inlet 12. The release and retraction of the hose 9 may, for example, be effected by a motor-controlled spoke wheel (not shown), which applies a counteracting force to the tensile force on the hose 9 in order to keep the hose 9 tensioned at all times.

Instead of the spoke wheel, the storage element 11 may also include a support wheel with a traveling axle. FIG. 2 shows a storage element for supply lines with a wheel having a traveling axle according to the prior art. A support wheel 14 with a traveling axle 15 is arranged in a housing 13. A spring 16 is fixed to the housing 13. The traveling axle 15 is arranged on another end of the spring 16. Guided around the support wheel 14 is a hose 9, which encloses the supply lines. The hose 9 is fastened to the housing 13 by a fixing clamp 18. Routing of the hose 9 is in an indicated direction 17. A change to the spring 16 effected by an exerted tensile force leads to a change in a position of the traveling axle 15 and thus to a change in the length of the portion of the hose 9 located in the housing 13. If the tensile loading of the hose 9 increases as a result of a movement of a robot arm (not shown), this leads to a contraction of the spring 16, using which the length of the portion of the hose 9 within the housing is reduced. An extra portion of the hose 9 is thereby available for movement of the robot arm. If the tensile loading of the hose 9 decreases as a result of a movement of the robot arm, this results in a relaxation of the spring 16, using which the length of the portion of the hose 9 within the housing increases. The portion of the hose 9 available for movement of the robot arm is thus reduced. Reference character 19 shows a direction of the hose movement upon movement of the robot arm.

### SUMMARY AND DESCRIPTION

One disadvantage of the known arrangement for guidance of the supply lines is that the hose, including the supply lines, is subjected to severe tensile and torsional strain. Damage to the hose and supply lines caused by this continuous strain may not be wholly prevented.

The present embodiments may obviate one or more of the drawbacks or limitations in the related art. For example, an improved robot arrangement is provided.

In one embodiment, an arrangement includes a robot arm formed from arm members. The robot arm carries a device fed by at least one electrical supply line. The arrangement has at least one guide element fixed to one of the arm members for guidance of the at least one electrical supply line on the robot arm. The at least one guide element is, for example, arranged rotatably about a longitudinal axis of the one arm member. Upon rotation of one or more arm members, rotatable guidance of the at least one electrical supply line around the arm members thereby takes place. Damage to cladding of the robot arm caused by abrasion from the at least one electrical supply line is prevented. Damage to the at least one supply line is avoided as a result of reduced tensile forces on the supply line.

In one embodiment, the at least one electrical supply line may be arranged in a hose. The advantage is that the at least one electrical supply line is thereby protected from damage. Flexible hoses may be used for this purpose, as the flexible hoses exhibit a high degree of flexibility in all directions while being very robust.

In an advantageous embodiment, the arrangement may have at least one storage element for flexible accommodation and release of the at least one electrical supply line.

In one embodiment, the at least one storage element may be arranged on the robot arm. The strong tensile and torsional strain on the at least one electrical supply line or the hose is thereby advantageously reduced, and the danger of damage to the at least one electrical supply line or the hose is minimized.

The at least one storage element may be arranged on a ceiling of a room, in which the robot is located.

In one embodiment, the at least one storage element may include a wheel with a torsion spring that exerts a restoring force. A stored length of supply line or hose is wound onto an outside diameter of the wheel. Advantageously, the torsion spring provides a constant tension of the supply line or of the hose.

In an advantageous manner, the at least one storage element may include a support wheel with a traveling axle.

In another embodiment, the traveling axle is spring-loaded. Using the spring-loading of the traveling axle, additional portions of hose may be made available from the at least one storage element for movements of the robot arm upon increased tensile loading of the hose, and upon reduced tensile loading of the hose, to retract portions of hose no longer required for movement of the robot arm into the at least one storage element.

The present embodiments also provide a C-arm X-ray system with an arrangement having a robot with a robot arm formed from arm members. The robot arm carries a device fed by at least one electrical supply line. The arrangement has at least one guide element fixed to one of the arm members for guidance of the at least one electrical supply line on the robot arm. The at least one guide element is, for example, arranged rotatably about a longitudinal axis of the one arm member.

### BRIEF DESCRIPTION OF THE DRAWINGS

FIG. 1 shows an arrangement for guidance of supply lines for robots according to the prior art;

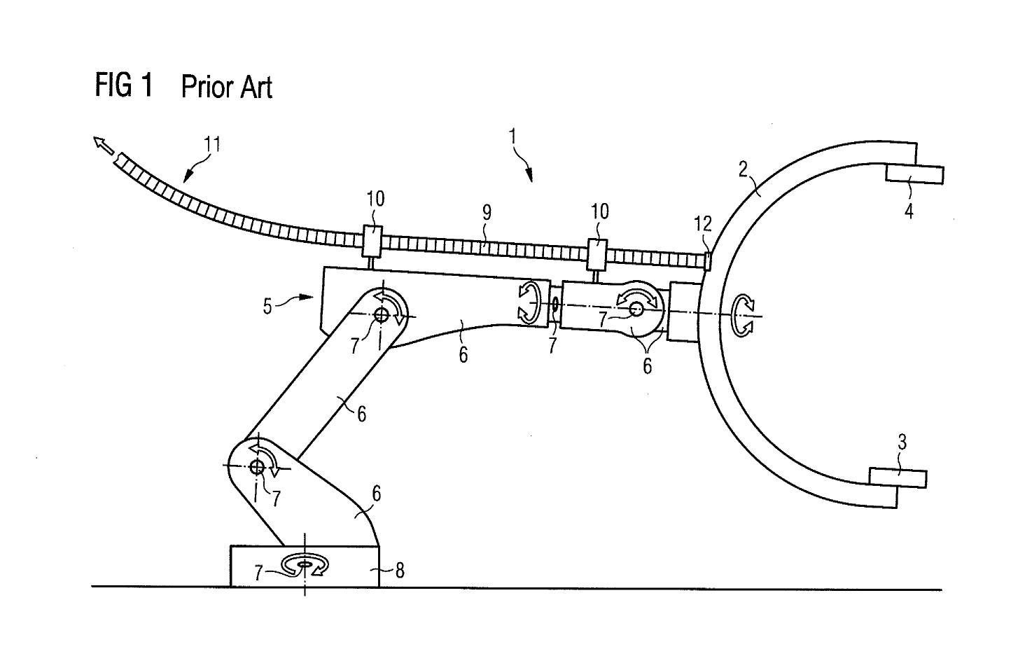

FIG. 2 shows a storage element for supply lines with a wheel with a traveling axle according to the prior art; and

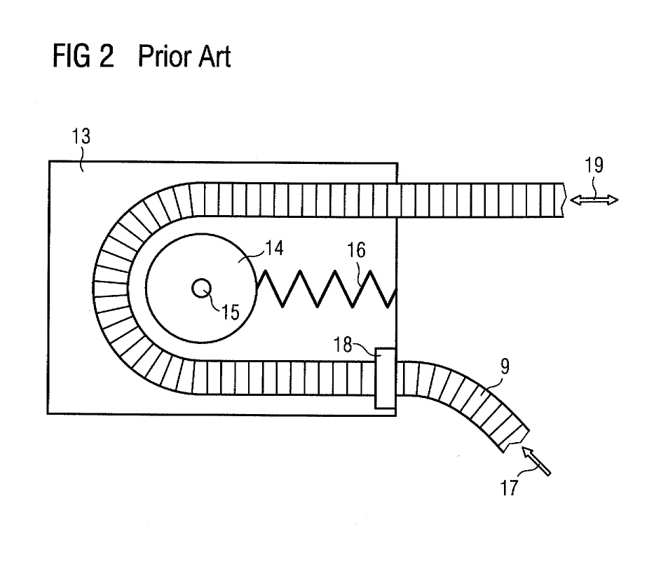

FIG. 3 shows one embodiment of an arrangement for guidance of supply lines with rotatable guide elements for robots.

### DETAILED DESCRIPTION OF THE DRAWINGS

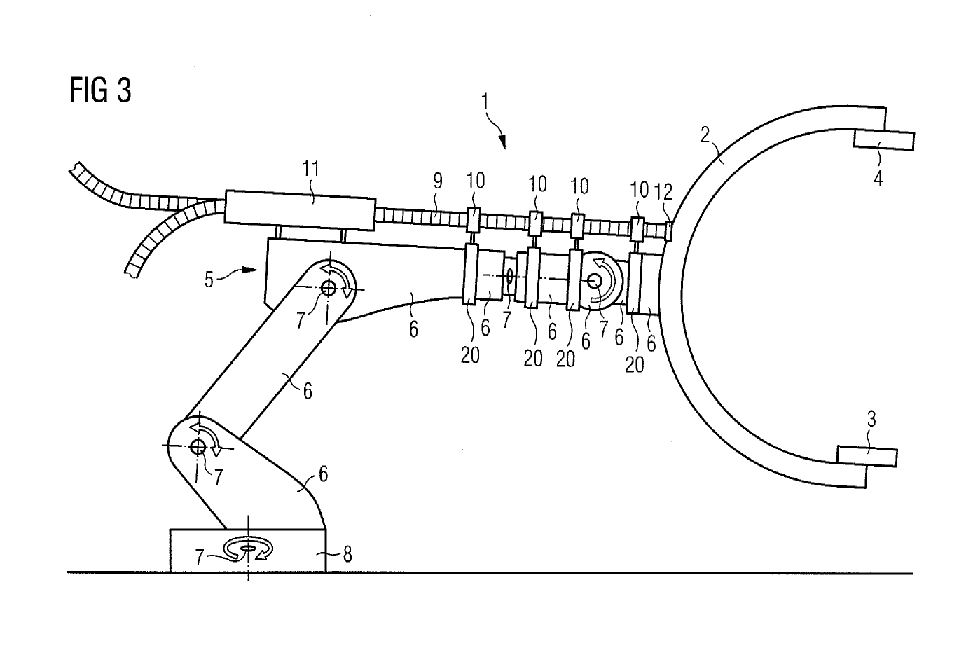

FIG. 3 shows one embodiment of an arrangement for guidance of supply lines with rotatable guide elements for robots. A C-arm X-ray system 1 includes a C-arm 2 with a radiation source 3 and a radiation detector 4. The C-arm 2 is arranged on a robot arm 5. The robot arm 5 has a plurality of arm members 6 that are connected to each other, to the C-arm 2, and to a robot stand 8 via revolute joints 7. The radiation source 3 and the radiation detector 4 arranged on the C-arm 2 are fed via supply lines (not shown), which are routed to the C-arm 2 within a hose 9. A storage element 11 attached to the robot arm 5 takes up the length of hose along with the amount of supply line necessary to provide freedom of movement, and releases the hose 9 and the supply lines as required, depending on movements performed by the robot arm 5. The storage element 11 releases the hose 9 when tensile loading of the hose 9 increases as a result of a movement of the robot arm 5, and retracts the hose 9 when the tensile loading of the hose 9 reduces through a movement of the robot arm 5. The hose 9 ends on the C-arm 2 in a supply line inlet 12. The release and retraction of the hose 9 may, for example, be effected by a motor-controlled spoke wheel (not shown), which applies a counteracting force to the tensile force on the hose 9 in order to keep the hose 9 tensioned at all times.

The hose 9 is guided along individual arm members 6 by guide elements 10. A guide element 10 is embodied such that the hose 9 may slide through the guide element 10 in a longitudinal direction if additional hose 9 is required as a result of a movement of the arm members 6 or of the C-arm 2, or the hose 9 is released once more. The guide elements 10 may be supported in a rotatable and/or jointed manner (e.g., on a ball-and-socket joint with limiting cuff) in order to enable orientation of the guide elements 10 along a direction of span of the hose 9. Excessive kinking of the hose 9 at the guide element 10 may thus be prevented.

According to the present embodiments, a guide element 10 is arranged in a movable, traveling manner in a guide rail 20 that encircles an arm member 6. The guide element 10 is thereby arranged in a movable, traveling manner about a longitudinal axis of an arm member 6, using which flexible guidance of the hose 9 around the robot arm 5 is effected. Upon rotation of one or more arm members 6, rotatable and movable guidance of the hose 9 or of the supply lines around the arm members 6 takes place. Damage to cladding of the robot arm 5 caused by abrasion from the hose 9 is prevented. Damage to the hose 9 is avoided as a result of the reduced tensile forces on the hose 9. The guide elements 20 may be attached to the cladding of the arm member 6 or integrated into the cladding.

While the present invention has been described above by reference to various embodiments, it should be understood that many changes and modifications can be made to the described embodiments. It is therefore intended that the foregoing description be regarded as illustrative rather than limiting, and that it be understood that all equivalents and/or combinations of embodiments are intended to be included in this description.

1. An arrangement comprising:
a robot comprising a robot arm formed from arm members, the robot arm carrying a device fed by at least one electrical supply line; and
at least one guide element fixed to one of the arm members for guidance of the at least one electrical supply line on the robot arm,
wherein the at least one guide element is arranged rotatably about a longitudinal axis of the one arm member.

2. The arrangement as claimed in claim 1, wherein the at least one electrical supply line is arranged in a hose.

3. The arrangement as claimed in claim 1, further comprising at least one storage element for the flexible accommodation and release of the at least one electrical supply line.

4. The arrangement as claimed in claim 3, wherein the at least one storage element is arranged on the robot arm.

5. The arrangement as claimed in claim 3, wherein the at least one storage element is arranged on a ceiling of a room, in which the robot is located.

6. The arrangement as claimed in claim 3, wherein the at least one storage element comprises a wheel with a torsion spring exerting a restoring force.

7. The arrangement as claimed in claim 3, wherein the at least one storage element comprises a support wheel with a traveling axle.

8. The arrangement as claimed in claim 7, wherein the traveling axle is spring-loaded.

9. The arrangement as claimed in claim 2, further comprising at least one storage element for the flexible accommodation and release of the at least one electrical supply line.

10. The arrangement as claimed in claim 4, wherein the at least one storage element is arranged on a ceiling of a room, in which the robot is located.

11. The arrangement as claimed in claim 4, wherein the at least one storage element comprises a wheel with a torsion spring exerting a restoring force.

12. The arrangement as claimed in claim 5, wherein the at least one storage element comprises a wheel with a torsion spring exerting a restoring force.

13. The arrangement as claimed in claim 4, wherein the at least one storage element comprises a support wheel with a traveling axle.

14. The arrangement as claimed in claim 5, wherein the at least one storage element comprises a support wheel with a traveling axle.

15. The arrangement as claimed in claim 6, wherein the at least one storage element comprises a support wheel with a traveling axle.

16. A C-arm X-ray system comprising:
a C-arm component; a robot comprising a robot arm formed from arm members, the robot arm carrying a the C-arm component fed by at least one electrical supply line; and
at least one guide element fixed to one of the arm members for guidance of the at least one electrical supply line on the robot arm,
wherein the at least one guide element is arranged rotatably about a longitudinal axis of the one arm member.

17. The C-arm X-ray system as claimed in claim 16, wherein the at least one electrical supply line is arranged in a hose.

18. The C-arm X-ray system as claimed in claim 16, further comprising at least one storage element for the flexible accommodation and release of the at least one electrical supply line.

19. The C-arm X-ray system as claimed in claim 18, wherein the at least one storage element is arranged on the robot arm.

20. The C-arm X-ray system as claimed in claim 18, wherein the at least one storage element is arranged on a ceiling of a room, in which the robot is located.
